(19) United States
(12) Patent Application Publication
(10) Pub. No.: US 2014/0113168 A1
(43) Pub. Date: Apr. 24, 2014

(54) FRAME FOR AN ENERGY STORAGE DEVICE, BATTERY CELL WITH THE FRAME AND THE ENERGY STORAGE DEVICE, BATTERY WITH TWO OF THESE BATTERY CELLS AND ALSO METHOD FOR PRODUCING THE FRAME

(71) Applicant: Li-Tec Battery GmbH, Kamenz (DE)

(72) Inventor: Tim Schaefer, Harztor (DE)

(73) Assignee: Li-Tec Battery GmbH, Kamenz (DE)

(21) Appl. No.: 14/060,354

(22) Filed: Oct. 22, 2013

Related U.S. Application Data
(60) Provisional application No. 61/717,171, filed on Oct. 23, 2012.

(30) Foreign Application Priority Data
Oct. 23, 2012 (DE) 10 2012 020 791.3

(51) Int. Cl. H01M 10/48; H01M 2/02

(52) U.S. Cl. CPC H01M 10/486; H01M 10/48; H01M 2/021
USPC 429/91; 429/90; 29/623.1

(57) ABSTRACT

A frame for an electrochemical energy storage device, which comprises two current conductors of different polarity, wherein the current conductors are used for exchanging electrical charge with the energy storage device,
with an accommodation space, configured for at least partially accommodating the energy storage device,
with a frame body, configured for delimiting the accommodation space with respect to the surroundings,
with an electrical connecting device, configured for contacting one of these current conductors, configured for electrically connecting to a further one of these energy storage devices, or to a consumer,
with a measuring device, configured for detecting a parameter of the energy storage device, wherein the parameter allows a conclusion as to an, in particular undesired, operating state of the energy storage device,
with an in particular capacitive first communication device, configured for transmitting one of these parameters, data and/or signals, particularly to a superordinate control device.

### CROSS-REFERENCE TO RELATED APPLICATIONS

The present application claims the benefit of U.S. Provisional Patent Application Ser. No. 61/717,171, filed Oct. 23, 2012, the entire content of which is incorporated herein by reference. The present application also claims priority to German Patent Application 10 2012 020 791.3, filed Oct. 23, 2012, the entire content of which is incorporated herein by reference.

The present invention relates to a frame for an energy storage device, a battery cell with the frame and the energy storage device, a battery with two of these battery cells and also a method for producing the frame. The invention is described in connection with lithium-ion batteries for supplying consumers, particularly automotive drives. It is pointed out that the invention can also be used independently of the design of the energy storage device or independently of the nature of the drive supplied.

Batteries with a plurality of interconnected electrochemical battery cells for supplying consumers, particularly automotive drives are known from the prior art. The battery cells each comprise an energy storage device which can supply electrical energy. An electrochemical energy storage device of this type ages calendrically and due to use or charge exchange. Thus, the energy or charge capacity which can be removed from the energy storage device and the time interval, during which the consumer can be supplied, fall.

The unsatisfactory economic efficiency of some known batteries during their operation is sometimes found to be problematic.

It is an object of the invention to provide a battery, the economic efficiency of which, particularly over a relatively long period of time, is improved.

The object is achieved by a frame according to Claim 1. Claim 7 describes a battery cell with one of these frames and one of these energy storage devices. Claim 8 describes a battery with at least two of these battery cells. The object is also achieved by means of a production method according to Claim 9 for one of these frames. Preferred developments of the invention are the subject of the subclaims.

The frame according to the invention is intended for an electrochemical energy storage device. The energy storage device comprises two current conductors of different polarity. The current conductors are equipped with the energy storage device for exchanging electrical charge. The frame comprises an accommodation space which is configured to accommodate the energy storage device at least to some extent. Further, the frame comprises a frame body which is configured to delimit the accommodation space with respect to the surroundings. Further, the frame comprises one, two or a plurality of electrical connecting devices. This electrical connecting device is configured for contacting one of these current conductors. Further, this electrical connecting device is configured for electrically connecting to a further one of these energy storage devices or to a consumer. Further, the frame comprises a measuring device which is configured for detecting at least one parameter of the energy storage device. This at least one parameter allows a conclusion as to an, in particular undesired, operating state of the energy storage device. Further, the frame comprises an in particular capacitive first communication device, which is configured for transmitting at least one of these parameters and/or for transmitting further data and/or signals, particularly to a superordinate control device.

The frame according to the invention comprises numerous devices, termed functional devices in the following, which can support the proper or correct operation of the energy storage device, particularly within a battery. As time progresses, due to higher operating temperatures and/or due to numerous exchanges of charge, the electrochemical energy storage device can age. As a consequence of the ageing, the capacity of the energy storage device for storing or supplying energy, also termed the charge capacity, drops. Particularly if one individual energy storage device ages more strongly than the remaining ones in the same battery, the electrical charge which can be drawn from the battery drops. In this case, a residual charge remains in the remaining energy storage devices in each case, which sometimes cannot be withdrawn, particularly in the case of series connection of the energy storage devices. If the more strongly aged energy storage device is replaced with a “younger” energy storage device, then the residual charges can then again also be called upon for supplying a consumer. Due to the fact that the frame comprises these functional devices instead of the energy storage device, the energy storage device can be configured in a technically simpler manner. With the simpler construction of the energy storage device without functional devices, a cost saving may accompany the production of this energy storage device. Thus, the economic efficiency during the operation of the battery is improved and the underlying object is achieved.

In the sense of the invention, an electrochemical energy storage device is understood to mean a device which is used in particular for providing electrical energy. The energy storage device is configured to convert supplied electrical energy into chemical energy and to store the same as chemical energy. Further, the energy storage device is configured to convert stored chemical energy into electrical energy before the energy storage device supplies this electrical energy to a consumer. Preferably, the energy storage device is essentially constructed to be cuboidal.

The energy storage device comprises at least two electrodes of different polarity. These electrodes of different polarity are spaced by means of a separator, wherein the separator is conductive for ions, but not for electrons. Two electrodes of different polarity are spaced in the energy storage device by means of a separator. The separator is permeable for ions but not for electrons. Preferably, the separator contains at least one part of the electrolyte or the conductive salt. Preferably, the electrolyte is formed without a liquid portion in particular after the closure of the energy storage device. Preferably, the conductive salt contains lithium ions. Particularly preferably, lithium ions are embedded or intercalated into the negative electrode during charging and released again during discharging.

In the sense of the invention, a current conductor is to be understood to mean a device which is in particular used for the conduction of electrons between one of the electrodes of the energy storage device and a consumer or between one of the electrodes and an adjacent energy storage device. To this end, the current conductor is electrically, preferably materially connected to one of the electrodes of the energy storage device. Preferably, the current conductor is at least indirectly connected to a consumer which is to be supplied. The current conductor comprises a first region which extends into the surroundings of the energy storage device. The first region can be at least indirectly electrically connected to a consumer to be supplied or to a second, in particular adjacent energy storage device, in particular via a connecting device, preferably via a contact rail, flexible connector or a connection cable.

In the sense of the invention, an accommodation space is to be understood to mean a space which is in particular used to accommodate the energy storage device at least to some extent. Preferably, the energy storage device essentially finds space completely in this accommodation space. Particularly preferably, the accommodation space is configured for positive-fitting and/or non-positive-fitting accommodation of the energy storage device.

In the sense of the invention, a frame body is to be understood to mean a device which is in particular used to delimit the accommodation space, particularly with respect to the surroundings. The frame body is adapted at least in certain areas to the shape of the energy storage device. When the energy storage device is inserted into the accommodation space, individual sections of the frame body extend along one boundary surface of the energy storage device in each case. The accommodation space is formed by a recess of the frame body. The frame body is realised using an electrically insulating material. Preferably, the frame body is realised using an, in particular curable, polymer material, particularly preferably using a thermoplastic or duroplastic. Preferably, the frame body is fibre-filled, at least in certain sections, particularly for increased mechanical stability, particularly preferably with glass fibres, aramid fibres, rock wool and/or carbon fibres.

In the sense of the invention, an electrical connecting device is to be understood to mean a device which is in particular configured for contacting one of these current conductors, which is in particular configured for electrically connecting to a further one of these energy storage devices, in particular of the same battery, or to a consumer. Preferably, the electrical connecting device is constructed using a metal, particularly preferably using aluminium, copper, iron, nickel or an alloy with one of these metals. Preferably, the electrical connecting device extends in particular through the frame body, from the energy storage device inserted into the accommodation space to the surroundings. Preferably, the electrical connecting device is constructed using a metal sheet, particularly preferably as a sheet-metal pressed part. Preferably, the electrical connecting device can be connected, particularly in a materially connected manner, to and is preferably constructed integrally with the frame body.

In the sense of the invention, a measuring device is to be understood to mean a device which is in particular used to detect a parameter of the energy storage device. The measuring device is preferably configured to supply a measured value, which is representative for this detected parameter, at least from time to time. Preferably, the measuring device comprises at least one or a plurality of measuring probes or sensors, which are in each case configured for detecting a certain parameter of the energy storage device. Preferably, the measuring device or the measuring probes thereof can be connected to the frame body, particularly in a materially connected manner. Preferably, the measuring device is configured to independently, particularly periodically, detect at least one of these parameters and supply an associated measured value. Preferably, the measuring device can provide the detected parameter or the associated measured value as a proportional electrical signal, particularly as electric voltage or electric current. Preferably, the measuring device can supply the detected parameter or the associated measured value to the first communication device. Preferably, the measuring device can be connected, particularly in a materially connected manner, to and is preferably constructed integrally with the frame body.

In the sense of the invention, a parameter is to be understood to mean a parameter in particular of the energy storage device, which in particular
permits a conclusion as to the presence of a desired or predetermined operating state of the energy storage device, and/or
permits a conclusion as to the presence of an unplanned or undesired operating state of the energy storage device, and/or
can be determined by means of a measuring probe or sensor, wherein the measuring probe supplies a signal at least intermittently, preferably an electric voltage or an electric current, and/or
can be processed by a control device, in particular a battery control device, in particular can be compared with a target value, in particular can be linked with another detected parameter, and/or
allows information about the cell voltage, that is the electric voltage of the energy storage device, the cell current, i.e. the current intensity of the electric current into the energy storage device or out of the energy storage device, a temperature of the energy storage device, the internal pressure of the energy storage device, the integrity of the energy storage device, the release of a substance from the energy storage device, the presence of a foreign substance in particular from the surroundings of the energy storage device and/or the charging state, and/or suggests transferring the energy storage device to a different operating state.

The following fall under the term undesired operating state of the energy storage device in the sense of the invention: too large or too low a temperature of the energy storage device, too large an internal pressure of the temperature device, too low or too large a cell voltage, too large a cell current, the presence of a leak of the energy storage device, wherein electrolyte can escape or a substance from the surroundings can penetrate into the energy storage device, too low or too high a charging state of the energy storage device. An undesired operating state is in particular characterised by a safe operation of the energy storage device not appearing possible, particularly without endangering the energy storage device or the surroundings.

In the sense of the invention, a first communication device is understood to mean a device which is in particular configured for transmitting one of these parameters, one of these measured values, data and/or signals to a superordinate control device in particular. Preferably, the first communication device is configured to accept a control command from a superordinate control device. Preferably, the first communication device is configured to accept one of these electrical signals from the measuring device. Preferably, the first communication device can be connected, particularly in a materially connected manner, to and is preferably constructed integrally with the frame body.

The following are regarded as being functional devices in the sense of the invention, which are used for the orderly function or the correct usage of one of these energy storage devices: these connecting devices, this measuring device, the measuring probes thereof, this first communication device, this current limiting device which is explained later, this cell control device which is explained later, these connection elements which are explained later, this first fixing device which is explained later, this second fixing device which is explained later. Some of these functional devices are to be supplied with energy during the correct use of the energy storage device.

The developments of the invention which are to be preferred are described in the following.

According to a preferred configuration, the frame body is constructed with an essentially cuboidal recess, particularly in the case of an essentially cuboidal energy storage device. Alternatively, the frame body is constructed with an essentially cylindrical recess, particularly in the case of an essentially cylindrical energy storage device. These preferred configurations offer the advantage that an essentially positive-fitting accommodation of the energy storage device is possible.

According to a preferred development, the frame comprises one, two or a plurality of first fixing devices which are configured for mechanically connecting the frame body to a further one of these frames in particular. In the sense of the invention, a first fixing device is understood to mean a device which is in particular configured for mechanically connecting the frame body to a further one of these frames in particular, particularly to a frame holding device of a superordinate battery. Preferably, the first fixing device is constructed as a through-hole, dovetail guide, groove or feather key, hook or eye, with an in particular spring-loaded clip, with a snap-in device or the like. Preferably, the first fixing device finds a counterpart piece in a further, in particular adjacent, one of these frames. Preferably, the first fixing device can be connected, particularly in a materially connected manner, to the frame body. Preferably, the first fixing device comprises the same material as the frame body.

According to a preferred development, the first communication device is configured for capacitive signal transmission. To this end, the first communication device comprises one or a plurality of electrically chargeable capacitor surfaces. Preferably, the at least one capacitor surface can be connected, particularly in a materially connected manner, to the frame body. Preferably, the first communication device is configured, particularly by means of this capacitor surface, to exchange data and/or signals with an information bus of the superordinate battery. Preferably, the first communication device comprises two of these capacitor surfaces and is configured for capacitive, differential signal transmission by means of these two capacitor surfaces. This preferred development offers the advantage that a signal transmission can be associated with fewer transmission errors.

According to a preferred development, the frame body is configured with one or a plurality of frame elements which extend along an element longitudinal axis in each case. Preferably, at least one of the dimensions of one of these frame elements essentially corresponds to one of the dimensions of the energy storage device. Preferably, at least two of these frame elements can be connected, particularly in a materially connected manner, to one another, wherein the element longitudinal axes thereof particularly preferably lie at an angle of essentially 90° with respect to one another. Preferably, one or a plurality of these frame elements comprise an essentially rectangular, triangular, elliptical or circular cross section.

According to a first preferred configuration, the frame body comprises three of these frame elements. The element longitudinal axes of the first and second frame elements are essentially parallel to one another and together orientated essentially perpendicularly to the element longitudinal axis of the third frame element. The first and the second frame elements are spaced from one another by means of the third frame element, so that a space, that is the accommodation space, remains between the first and the second frame elements. Thus, these frame elements delimit the accommodation space. Preferably, the first or third frame element is configured to hold the electrical connecting devices. Preferably, at least one of these frame elements is configured to hold one or a plurality of these first fixing devices. This preferred configuration offers the advantage that the insertion of the energy storage device into the accommodation space is simplified.

According to a second preferred configuration, the frame body comprises four of these frame elements. The element longitudinal axes form an, in particular rectangular, quadrilateral. Thus, these frame elements delimit the accommodation space which is arranged between the frame elements. Preferably, one of the frame elements is configured to hold the electrical connecting devices. Preferably, at least one of these frame elements is configured to hold one or a plurality of these first fixing devices. This preferred configuration offers the advantage that the protection of the energy storage device by means of the frame body is improved.

According to a further preferred development, the electrical connecting device can be connected, particularly in a materially connected manner, to the frame body. This preferred development offers the advantage that the mechanical stability of the frame is improved. This preferred development offers the advantage that the contacting of the energy storage device is improved.

According to a further preferred development, the electrical connecting device comprises an, in particular spring-loaded, connection element for one of these current conductors. Preferably, this connection element is constructed as an, in particular resilient, terminal. This preferred development offers the advantage that the contacting of the energy storage device is improved.

According to a further preferred development, the electrical connecting device comprises a current limiting device for limiting the exchange of electrical charge with the energy storage device. To this end, the current limiting device can be controlled in particular by means of a superordinate control device, particularly by means of a battery control device, in particular by means of the first communication device. Preferably, the current limiting device is configured for demand-dependent, in particular temperature-dependent, reduction of the cell current. This preferred configuration offers the advantage that a discharge which is as even as possible of the energy storage devices of the same battery is enabled. Preferably, the current limiting device is configured as a controllable switch for interruption of the cell current. This preferred configuration offers the advantage that the energy storage device connected to the electrical connecting device can be isolated by means of the current limiting device, particularly in the case of an undesired operating state.

According to a preferred development, the measuring device is configured with a voltage probe for detecting the voltage, particularly the terminal voltage of the energy storage device. Preferably, the voltage probe or the measuring device can be electrically connected to the current conductors of the energy storage device. Preferably, the voltage probe or the measuring device can be electrically connected to the electrical connecting device, particularly preferably to the connection element thereof. This preferred development offers the advantage of an improved control of the energy storage device. This preferred development offers the advantage of a safe operation of the energy storage device.

According to a preferred development, the measuring device is configured with a temperature probe for detecting a temperature of the energy storage device. Preferably, the temperature probe or the measuring device can be connected in a thermally conductive manner to an enveloping surface and/or to one of the current conductors of the energy storage device. Preferably, the temperature probe can be connected to one of the frame elements, particularly in a materially connected manner, such that the temperature probe achieves thermally conductive contact with an enveloping surface and/or with one of the current conductors in the case of an energy storage device inserted into the accommodation space. This preferred development offers the advantage of an improved control of the energy storage device. This preferred development offers the advantage of a safe operation of the energy storage device.

According to a preferred development, the frame comprises an identifier, wherein the identifier is used for identifying or addressing the frame or the energy storage device associated with the frame. Preferably, the identifier can be transmitted particularly together with one of these parameters, particularly together with one of these measured values, by means of the first communication device. Preferably, the identifier is stored in the first communication device, the measuring device or the cell control device, which is explained later. Preferably, the first communication device is configured to only provide received signals to the measuring device or the cell control device, which is explained later, if this identifier was also received together with these received signals, particularly if the first communication device is signal-connected to an information bus, which is explained later. This preferred development offers the advantage of an improved control of the energy storage device. This preferred development offers the advantage of a safe operation of the energy storage device. This preferred development allows the equipping of the superordinate battery with the information bus, which is explained later.

According to a preferred development, the frame comprises a second fixing device, which is configured to releasably fix the energy storage device in the accommodation space which can be connected to the frame body. Preferably, one or two of these electrical connecting devices or one or two of these connection elements are opened or closed together with the second fixing device. This preferred development offers the advantage that the fixing of the energy storage device in the accommodation space is improved. This preferred development offers the advantage that the exchange of the energy storage device is simplified.

According to a preferred embodiment of the frame, the following are connected to the frame, particularly in a non-positive fitting and/or materially connected manner: one or a plurality of these first fixing devices, two of these electrical connecting devices, this measuring device, the first communication device, particularly one of these voltage probes, in particular one of these temperature probes, particularly one or two of these capacitor surfaces, particularly the cell control device presented later. This preferred embodiment offers the advantage that the devices and probes mentioned can be connected to the frame body in a more mechanically stable manner.

A battery cell preferably comprises one of these previously described frames and one of these energy storage devices. The energy storage device is accommodated in the accommodation space during the supply of a consumer and the current conductors of different polarity are connected to various of these electrical connecting devices, electrically and mechanically in particular. Two of these electrical connecting devices extend at least to some extent out of the frame body into the surroundings of the frame, particularly for the electrical connection to the consumer or for electrical interconnection with at least one further of these battery cells. Preferably, the energy storage device is held in the frame or in the accommodation space by means of the second fixing device. This preferred configuration of a battery cell offers the advantage that the exchange of the, in particular aged, energy storage device is simplified. This preferred configuration of a battery cell offers the advantage that when constructing the frame with a few of the previously mentioned functional devices, the energy storage device itself can be produced more simply from a technical standpoint and more cost effectively.

Preferably, the battery cell comprises a cell control device which is used in particular to control functions of the measuring device, the first communication device and/or the energy storage device. Preferably, the cell control device and the measuring device are constructed integrally. Particularly preferably, the cell control device can be connected, particularly in a materially connected manner, to the frame body. This preferred configuration offers the advantage that a superordinate control device, particularly a battery control device, can be unburdened.

Preferably, at least temporarily, some of the previously mentioned functional devices, particularly the measuring device, the measuring probes thereof, the first communication device, the first communication device, the cell control device, the current limiting device, can be supplied with energy from the energy storage device. This preferred configuration offers the advantage that it is possible to dispense with a separate energy supply of the energy storage device.

Preferably, the energy storage device comprises a charging capacity of at least 3 ampere hours [Ah], further preferably of at least 5 Ah, further preferably of at least 10 Ah, further preferably of at least 20 Ah, further preferably of at least 50 Ah, further preferably of at least 100 Ah, further preferably of at least 200 Ah, further preferably of at most 500 Ah. This configuration offers the advantage of an improved service life of the consumer supplied by the energy storage device.

Preferably, a current of at least 50 A, further preferably of at least 100 A, further preferably of at least 200 A, further preferably of at least 500 A, further preferably of at most 1000 A can be drawn from the energy storage device at least temporarily, preferably during at least one hour. This configuration offers the advantage of an improved performance of the consumer supplied by the energy storage device.

Preferably, the energy storage device can at least temporarily supply a voltage, particularly a terminal voltage of at least 1.2 V, further preferably of at least 1.5 V, further preferably of at least 2 V, further preferably of at least 2.5 V, further preferably of at least 3 V, further preferably of at least 3.5 V, further preferably of at least 4 V, further preferably of at least 4.5 V, further preferably of at least 5 V, further preferably of at least 5.5 V, further preferably of at least 6 V, further preferably of at least 6.5 V, further preferably of at least 7 V, further preferably of at most 7.5 V. Particularly preferably, the energy storage device comprises lithium and/or lithium ions. This configuration offers the advantage of an improved energy density of the energy storage device.

Preferably, the energy storage device can be operated at least temporarily, particularly during at least one hour, at an environmental temperature between −40° C. and 100° C., further preferably between −20° C. and 80° C., further preferably between −10° C. and 60° C., further preferably between 0° C. and 40° C. This configuration offers the advantage of an installation or use of the energy storage device for supplying a consumer, in particular a motor vehicle or a stationary system or machine, which is as free of limitation as possible.

Preferably, the energy storage device comprises a gravimetric energy density of at least 50 Wh/kg, further preferably of at least 100 Wh/kg, further preferably of at least 200 Wh/kg, further preferably of less than 500 Wh/kg. Preferably, the electrode assembly comprises lithium ions. This configuration offers the advantage of an improved energy density of the energy storage device.

According to a preferred embodiment, the energy storage device is provided for installation into a vehicle with at least one electric motor. Preferably, the energy storage device is provided to supply this electric motor. Particularly preferably, the energy storage device is provided to supply an electric motor of a drivetrain of a hybrid or electric vehicle at least temporarily. This configuration offers the advantage of an improved supplying of the electric motor.

According to a further preferred embodiment, the energy storage device is provided for use in a stationary battery, in particular in a buffer storage unit, as a device battery, industrial battery or starter battery. Preferably, the charge capacity of the energy storage device for these applications is at least 3 Ah, particularly preferably at least 10 Ah. This configuration offers the advantage of an improved supplying of a stationary consumer, in particular of a stationarily mounted electric motor.

According to a preferred development, the energy storage device is constructed with an electrode winding. This configuration offers the advantage of simpler producibility, in particular in that strip-shaped electrodes can be processed. This configuration offers the advantage that the nominal charging capacity, for example specified in ampere hours [Ah] or watt hours [Wh], less often in coulombs [C], can be increased in a simple manner by means of further windings. Preferably, the energy storage device is constructed with a flat electrode winding. This development offers the advantage that the same can be arranged in a space-saving manner next to a further flat electrode winding in particular within a battery.

According to a further preferred development, the energy storage device is constructed with an essentially cuboidal electrode stack. The electrode stack comprises a predetermined sequence of stack sheets, wherein each pair of electrode sheets of different polarity are separated by a separator sheet. This configuration of the energy storage device offers the advantage that the nominal charging capacity, for example specified in ampere hours [Ah] or watt hours [Wh], less often in coulombs [C], can be increased in a simple manner by adding further electrode sheets.

Particularly preferably, at least two separator sheets are connected to one another and encompass a delimiting edge of an electrode sheet. An energy storage device of this type with a separate, in particular meandering separator is described in WO 2011/020545. This development offers the advantage that a parasitic current originating from this delimiting edge to an electrode sheet of a different polarity is counteracted.

According to a first preferred embodiment, the at least one separator, which is not or only poorly electron-conductive, consists of an at least somewhat material-permeable substrate. The substrate is preferably coated on at least one side with an inorganic material. Preferably an organic material, which is preferably configured as a non-woven fleece, is used as a substrate which is at least partially permeable to material. The organic material, which preferably contains a polymer and particularly preferably a polyethylene terephthalate (PET), is coated with an inorganic, preferably ion-conducting material which is further preferably ion-conductive in a temperature range from −40° C. to 200° C. The inorganic material preferably contains at least one compound from the group of oxides, phosphates, sulphates, titanates, silicates, aluminosilicates with at least one of the elements Zr, Al, Li, particularly preferably zirconium oxide. Zirconium oxide in particular is used for substance integrity, nanoporosity and flexibility of the separator. Preferably, the inorganic ion-conductive material comprises particles with a largest diameter below 100 nm. This embodiment offers the advantage that the durability of the electrode assembly at temperatures above 100° C. is improved. A separator of this type is sold in Germany by Evonik AG under the brand name “Separion”, for example.

According to a second preferred embodiment, the at least one separator, which is not or only poorly electron-conductive, but is conductive for ions, consists at least overwhelmingly or completely of a ceramic, preferably of an oxide ceramic. This embodiment offers the advantage that the durability of the electrode assembly at temperatures above 100° C. is improved.

In a preferred configuration of the current conductor, the first region is constructed as a metal plate or as a plate with an electrically conductive, particularly metallic, coating. Preferably, the current conductor is constructed as a sheet-metal pressed part. This configuration offers the advantage that an essentially planar surface is present for simple electrical connection to a connecting device. This configuration offers the advantage that the current conductor for connecting to the electrical connecting device is constructed to be more mechanically stable. This configuration offers the advantage of reduced production costs. This configuration offers the further advantage that the current conductor is constructed in a satisfactorily mechanically stable manner for connection to one of the electrical connecting devices, for example a contact rail, flexible connector or power cable.

A preferred battery, particularly for supplying a consumer comprises at least:
two of the previously mentioned battery cells,
a battery control device, configured to control the operation, particularly a charging process and/or a discharging process, of at least one of the energy storage devices,
a second communication device, configured for communication with the first communication device,
a frame holding device, configured for holding one or a plurality of these frames or frame bodies,
a wiring device, configured for electrical connection to at least one of these electrical connecting devices, particularly configured for wiring the battery cells, particularly in series and/or parallel,
two battery connectors, configured for electrical connection to the consumer and/or to the wiring device.

Preferably, the battery comprises an information bus which is used in particular for exchanging signals with one or a plurality of these first communication devices, particularly for transmitting at least one of these parameters, measured values and/or data. Preferably, the information bus comprises at least one device for interaction with one or a plurality of these capacitor surfaces. Preferably, the information bus is signal-connected to the second communication device. This preferred configuration offers the advantage that the structure of the battery is simplified.

This preferred configuration of a battery offers the advantage that the exchange of an, in particular aged, energy storage device is simplified. This preferred configuration of a battery offers the advantage that when constructing the frame with a few of the previously mentioned functional devices, the energy storage devices themselves can be produced more simply from a technical standpoint and more cost effectively. This preferred configuration of a battery offers the advantage that the continued operation thereof can be more cost effective.

According to a preferred development, the electrical connecting devices are connected in series by means of the wiring device. This preferred development offers the advantage that a larger voltage can be supplied.

According to a preferred configuration, the wiring device is electrically connected to the battery connectors, so that the total voltage of the energy storage devices in particular can be tapped at the battery connectors.

According to a preferred development, a data storage device is assigned to the battery control. This data storage device is used for storing parameters, measured values, data, setpoint data, logic results from the comparison of measured data with setpoint data in particular, operating regulations, etc.

A preferred method for producing one of these frames comprises the steps:
S1 providing one or two of these electrical connecting devices in a forming tool,

S2 providing at least one of these first fixing devices, measuring devices, first communication devices and/or second connecting devices, preferably one of these cell control devices, preferably one of these second fixing devices in the forming tool, particularly before step S3,

S3 supplying an, in particular curable, polymer material to the forming tool, particularly overmoulding of at least one of this electrical connecting device, one of these first fixing devices, one of these measuring devices, one of these first communication devices and/or one of these second fixing devices, whereupon the frame body in particular is formed, particularly after the steps S1 and S2.

Preferably during step S4, particularly after step S3, the curable polymer material is allowed to cure, particularly with the supply of heat energy, whereupon the frame body in particular is formed.

Preferably, the polymer material is constructed as a thermoplastic or duroplastic. Preferably, the polymer material is fibre filled, particularly preferably with glass fibres, aramid fibres, rock wool and/or carbon fibres. This preferred configuration offers the advantage that the mechanical stability of the frame or frame body is improved.

With the previously mentioned sequence of steps, a particularly materially connected connection of the frame body to a few of these functional devices can be achieved. This preferred method offers the advantage that the durability or the mechanical stability of the frame is improved.

Further advantages, features and application possibilities of the present invention result from the following description in connection with the figures. In the figures:

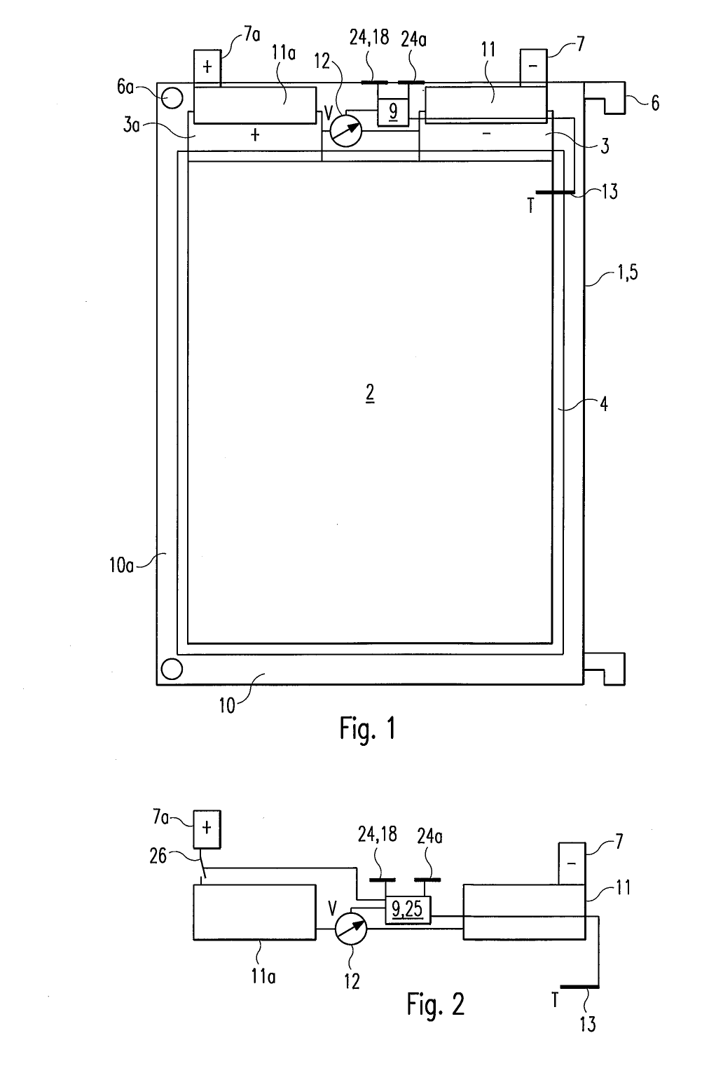

FIG. 1 schematically shows a preferred development of the frame and also an energy storage device,

FIG. 2 schematically shows a few devices of the frame according to a preferred development, without the frame body.

FIG. 1 schematically shows a preferred development of the frame 1 and also an energy storage device 2, which is inserted into the accommodation space 4 of the frame 1 or the frame body 5.

The frame body 5 is illustrated transparently, so that the measuring device 9, electrical connecting devices 6, the measuring probes 12, 13 and the first communication device 18 and also the arrangement thereof with respect to the energy storage device 2 can be recognised easily.

The frame body 5 comprises four frame elements 10, 10a and is constructed with a polymer material. The outline of the frame body 5 essentially corresponds to a rectangle. The thickness of the frame body 5 essentially corresponds to the thickness of the energy storage device 2.

The frame body 5 comprises a plurality of first fixing devices 6, 6a, constructed by way of example as hooks 6 for mounting into a groove for example, constructed by way of example as a through hole 6a, through which a tensioning device can be guided. By means of these first fixing devices 6, 6a, the frame body 5 can be held by a frame holding device, which is not illustrated.

The frame body 5 comprises two of these electrical connecting devices 7, 7a of different polarity, which extend in sections out of the frame body 5 into the surroundings. The electrical connecting devices 7, 7a each comprise one of these connection elements 11, 11a. The connection elements 11, 11a are constructed as spring-loaded connection terminals, into which the current conductors 3, 3a can be plugged.

The energy storage device 2 comprises two of these current conductors 3, 3a which are inserted into the connection elements 11, 11a and are both mechanically and electrically connected to these connection elements 11, 11a. Thus, the electric voltage of the energy storage device 2 can be present at the sections of the connecting devices 7, 7a which extend into the surroundings of the frame 1.

The measuring device 9 and also the voltage probes 12 and temperature probe 13 thereof are arranged with their supply lines within the frame body 5. The voltage probes 12 and the temperature probe 13 are arranged in such a manner that the voltage of the energy storage device 2 inserted into the accommodation space 4 and also the surface temperature thereof can be measured. The measuring device 9 is configured to supply measured values to the first communication device 18.

The first communication device 18 is configured to occasionally exchange signals with a superordinate control, particularly by means of an information bus, which is not illustrated. The first communication device 18 is constructed with a chargeable capacitor surface 24 which is essentially arranged in a surface of the frame body 5.

In a materially connected manner with one of its frame elements, the frame body 5 holds: the measuring device 9, the first communication device 18, a plurality of first fixing devices 6, 6a, two electrical connecting devices 7, 7a, the voltage probe 12, the temperature probe 13. This configuration offers the advantage that these devices or probes are held essentially firmly with respect to the frame 1. This configuration offers the advantage that the devices or probes mentioned are protected by the frame body 5. The energy storage device 2 to be inserted into the accommodation space 4 can advantageously be constructed without the devices or probes mentioned.

It is not illustrated that the second fixing device is connected to one of the frame elements and is used for the secure fixing of the energy storage device 2 in the accommodation space 4 or within the frame body.

FIG. 2 schematically shows a few devices of the frame 1 according to a preferred development, without the frame body. Differences compared with the preferred development according to FIG. 1 are presented in the following.

In this preferred development, the measuring device 9 is constructed integrally with the cell control device 25. The electrical connecting device 7a comprises a controllable current limiting device 26, here constructed as a switch. This switch 26 is constructed and arranged to electrically isolate the connection element 11a or the inserted current conductor (not illustrated) with respect to the wiring device (not illustrated) of the superordinate battery (not illustrated), particularly if commanded to do so by the cell control device 25.

In this preferred development, the first communication device 18 is constructed with two chargeable capacitor surfaces 24, 24a. Signal transmission can be improved with this design, wherein fewer transmission faults should arise.

### REFERENCE NUMBERS

1 Frame

2, 2a Energy storage device

3, 3a Current conductor

4 Accommodation space

5 Frame body

6, 6a First fixing device

7, 7a Electrical connecting device

8 Consumer

9 Measuring device

10, 10a Frame element

11, 11a Connection element

12 Voltage probe

13 Temperature probe

14 Second fixing device

15, 15a Battery cell

16 Battery

17 Battery control device

18 First communication device

19 Second communication device

20 Frame holding device

21 Wiring device

22, 22a Battery connector

23 Information bus

24 Capacitor surface

25 Cell control device

26 Current limiting device

V Electric voltage

T Temperature

1-9. (canceled)

10. A frame for an electrochemical energy storage device, which comprises two current conductors of different polarity, wherein the current conductors are configured to exchange electrical charge with the energy storage device, the frame comprising:
an accommodation space, configured to at least partially accommodate the energy storage device;
a frame body, configured to delimit the accommodation space with respect to the surroundings,
an electrical connecting device configured to contact a first one of the current conductors and to electrically connect to (a) a second one of these energy storage devices or (b) a consumer,
a measuring device configured to detect at least one parameter of the energy storage device to allow a conclusion as to an operating state of the energy storage device; and
a capacitive first communication device configured to transmit the at least one parameters and/or further data and/or signals to a superordinate control device.

11. The frame according to claim 10, further comprising a first fixing device configured to mechanically connect the frame body to a further like frame.

12. The frame according to claim 10, wherein at least one of the electrical connecting devices, the measuring device and the first communication device is configured to be materially connected to the frame body.

13. The frame according to claim 12, wherein the at least one of the electrical connecting devices, the measuring device and the first communication device is constructed integrally with the frame body

14. The frame according to claim 10, wherein the frame body includes a plurality of frame elements each of which extend along an element longitudinal axis, wherein at least two of the frame elements are configured to be connected to one another.

15. The frame according to claim 10, wherein
the electrical connecting device is configured to be materially connected to the frame body,
the electrical connecting device comprises a spring-loaded connection element for connection with one of the current conductors, and

16. The frame according to claim 15, wherein the electrical connecting device further comprises a current limiting device configured to limit the exchange of electrical charge with the energy storage device.

17. The frame according to claim 10, wherein the measuring device comprises at least one of (a) a voltage probe configured to detect the terminal voltage of the energy storage device and (b) a temperature probe configured to detect a temperature of the energy storage device.

18. The frame according to claim 10, further comprising an identifier for identifying or addressing the frame or the energy storage device, wherein the identifier is transmittable together with the at least one parameter via the first communication device.

19. The frame according to claim 10, further comprising a second fixing device, which is configured to fix the energy storage device in the accommodation space and which is connectible to the frame body.

20. A battery cell comprising:
a frame according to claims 10; and
the energy storage device, wherein the energy storage device is accommodated in the accommodation space and the current conductors of different polarity are connected to different of the electrical connecting devices.

21. A battery for supplying a consumer, the battery comprising:
at least two of the battery cells according to claim 20;
a battery control device configured to control the operation, including a charging process and/or a discharging process, of at least one of the energy storage devices;
a second communication device configured to communicate with the first communication device;
a frame holding device configured to hold at least one of the frame bodies;
a wiring device configured to electrically connect to at least one of the electrical connecting devices and to wire the battery cells in series and/or in parallel; and
two battery connectors configured to electrically connect to at least one of (a) the consumer and (b) the wiring device.

22. The battery according to claim 21, further comprising an information bus configured to be signal connected to the first communication device and the second communication device.

23. A method for producing the frame according to claim 10, the method comprising:
providing at least one of the electrical connecting devices in a forming tool;
providing in the forming tool at least one of (a) a first fixing device configured to mechanically connect the frame body to a further like frame, (b) the measuring device, (c) the first communication device, and (d) the second connecting device;
supplying a curable polymer material to the forming tool, thereby overmolding at least one of the (a) a first fixing device configured to mechanically connect the frame body to a further like frame, (b) the measuring device, (c) the first communication device, and (d) the second connecting device.
